(19) United States
(12) Patent Application Publication
(10) Pub. No.: US 2026/0071929 A1
(43) Pub. Date: Mar. 12, 2026

(54) A Torque Tester for Calibrating an Electronic Torque Wrench with Operator Guidance

(71) Applicant: Apex Brands, Inc., Apex, NC (US)

(72) Inventors: Bin Sun, Shanghai (CN); Henglian Luo, Shanghai (CN); Tong Li, Shanghai (CN)

(21) Appl. No.: 19/107,992

(22) PCT Filed: Sep. 1, 2022
(86) PCT No.: PCT/CN2022/116479

§ 371 Date: Feb. 28, 2025

(51) Int. Cl. G01L 25/00; B25B 23/142

(52) U.S. Cl. CPC G01L 25/003; B25B 23/1425

(57) ABSTRACT

A method is provided for calibrating an electronic torque wrench (100) engaged with a torque tester (302), according to a specified calibration procedure that includes increasing an applied torque to a target torque value, and a threshold time rate of change of the applied torque. The method includes detecting the applied torque produced from a rotational force applied by an operator to the electronic torque wrench (100). The method includes, as the applied torque is detected, determining a torque value of the applied torque, and a time rate of change of the applied torque. The torque value and the time rate of change are compared to respectively the target torque value and the threshold time rate of change. And a notification is output to guide the operator in the rotational force applied by the operator, and thereby the applied torque produced from the rotational force.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

A number of programs in which a torque wrench is used include use of a torque tester to periodically calibrate the torque wrench to a desired specification. Although electronic torque wrenches and torque testers provide a number of useful features, it is generally desirable to improve on existing designs.

### BRIEF SUMMARY

Example implementations of the present disclosure are directed to an apparatus such as a torque tester for calibrating an electronic torque wrench or other torque measurement device. The present disclosure includes, without limitation, the following example implementations.

Some example implementations provide a torque tester for calibrating an electronic torque wrench, according to a specified calibration procedure that includes increasing an applied torque to a target torque value, and a threshold time rate of change of the applied torque, the torque tester comprising: a recess configured to engage a boss of an electronic torque wrench, and thereby engage the electronic torque wrench with the torque tester; and processing circuitry configured to cause the torque tester to at least: detect the applied torque at the torque tester with which the electronic torque wrench is engaged, the applied torque produced from a rotational force applied by an operator to the electronic torque wrench; and as the applied torque is detected, determine a torque value of the applied torque; determine a time rate of change of the applied torque; perform comparisons of the torque value and the time rate of change to respectively the target torque value and the threshold time rate of change; and output a notification to the operator based on the comparisons, the notification output to guide the operator in the rotational force applied by the operator, and thereby the applied torque produced from the rotational force.

Some example implementations provide a method of calibrating an electronic torque wrench engaged with a torque tester, according to a specified calibration procedure that includes increasing an applied torque to a target torque value, and a threshold time rate of change of the applied torque, the method comprising: detecting the applied torque at a torque tester with which the electronic torque wrench is engaged, the applied torque produced from a rotational force applied by an operator to the electronic torque wrench; and as the applied torque is detected, determining a torque value of the applied torque; determining a time rate of change of the applied torque; performing comparisons of the torque value and the time rate of change to respectively the target torque value and the threshold time rate of change; and outputting a notification to the operator based on the comparisons, the notification output to guide the operator in the rotational force applied by the operator, and thereby the applied torque produced from the rotational force.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of a torque measurement device that may correspond to the electronic torque wrench of FIG. 1, according to some example implementations;

FIG. 3 illustrates a system for calibrating a torque measurement device such as an electronic torque wrench, according to various example implementations; and

FIGS. 4A, 4B, 4C, 4D, 4E and 4F are flowcharts illustrating various steps in a method of calibrating an electronic torque wrench engaged with a torque tester, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,”“information,” and similar terms may be at times used interchangeably.

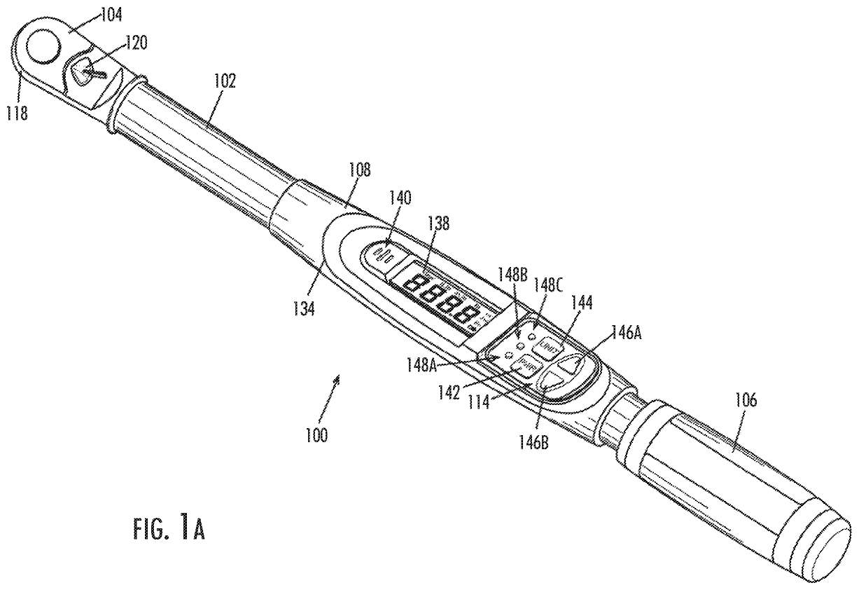

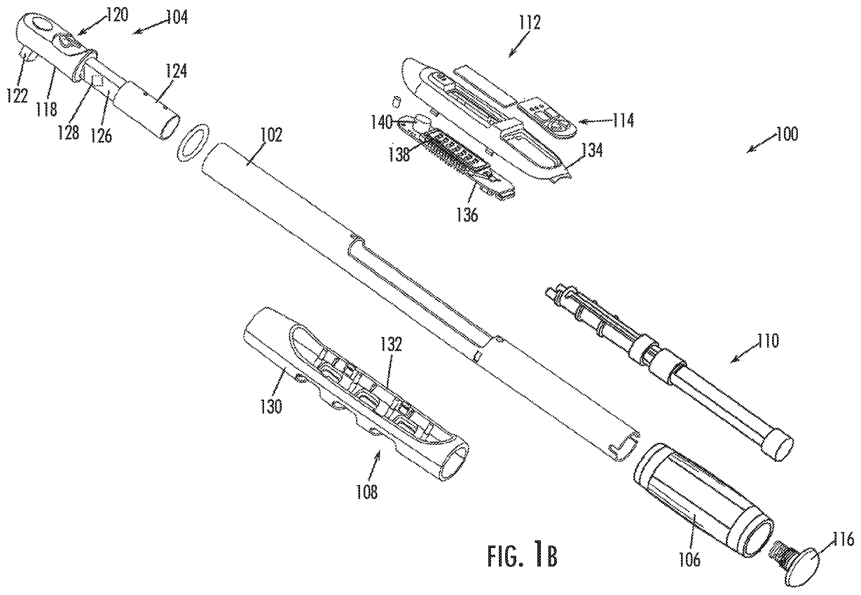

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a male square drive or boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

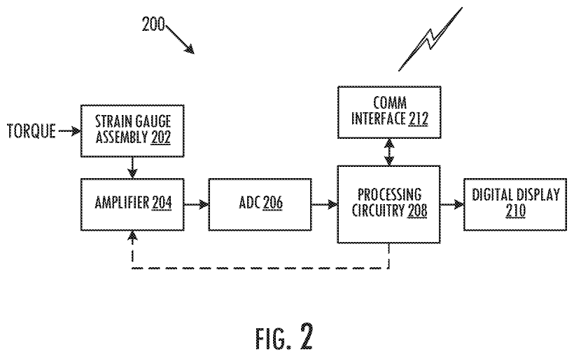

FIG. 2 illustrates a torque measurement device 200 for determining a torque value of an applied torque, according to some example implementations. The torque measurement device may be embodied in a number of different manners, and in some examples, the torque measurement device is an electronic torque wrench such as electronic torque wrench 100. In other examples, the torque measurement device is a torque tester, torque meter, torque transducer or the like. As shown, the torque measurement device includes a strain gauge assembly 202 (e.g., strain gauge assembly 128), an amplifier 204, an analog-to-digital converter (ADC) 206, and processing circuitry 208. In some examples in which the torque measurement device 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the torque measurement device 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the torque measurement device 200 further includes a digital display 210 (e.g., digital display 138), and the processing circuitry is configured to output the indication of the torque value to the digital display that is configured to display the torque value.

As also shown, the torque measurement device 200 may include a communication interface 212 is configured to enable the torque measurement device to telecommunicate with another apparatus by wire, or wirelessly by radio or optical communication. As described herein, the communication interface is an electronic circuit; and in various examples, the communication interface includes a cable connector, an antenna or optoelectronics for the electronic transmission of information over a (wired or wireless) data link between the apparatus and computer/computer hardware. Examples of suitable communication interfaces include a network interface controller (NIC), wireless NIC (WNIC) or the like.

To further illustrate calculation of the torque value according to various example implementations, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

In some examples, the processing circuitry 208 may utilize the equivalent digital values and a calibration function to calculate the torque value. One example of a suitable calibration function includes a plurality of line segments for use by the processing circuitry to convert the digital values of the equivalent digital electrical signals into equivalent torque values, according to some example implementations. In this regard, after assembly, each torque measurement device 200 may be calibrated in order to derive the calibration function. The torque measurement device may be used to measure known applied torque values at various points along an interval of torque values ranging from 0 to 100% of a preset maximum torque. The data points for the interval of torque values provide three different line segments of the graph of which the slopes (m) and y-intercepts (b) can be found using the equation y=m(x)+b. The calibration function may be defined to include the linear functions for the line segments, which may be stored in memory and used by the processing circuitry to determine equivalent torque values based on the equivalent digital values.

FIG. 3 illustrates a system 300 for calibrating a torque measurement device 200 such as an electronic torque wrench 100, according to various example implementations. According to various example implementations, the system includes the the torque measurement device and an apparatus for calibrating the torque measurement device. The apparatus may be embodied in a number of different manners. In the example shown in FIG. 3 in which the torque measurement device is an electronic torque wrench, the apparatus is embodied as a torque tester 302 that the electronic torque wrench is configured to engage. In this regard, the torque tester may include a female square drive or recess 304 configured to receive the boss 122 of the electronic torque wrench. The torque tester may include circuitry that is the same as or similar to the torque measurement device 200, including processing circuitry 306.

According to various example implementations of the present disclosure, the electronic torque wrench 100 is calibrated according to a specified calibration procedure that includes increasing an applied torque to a target torque value, and a threshold time rate of change of the applied torque. During calibration, the processing circuitry 306 configured to cause the torque tester 302 to detect the applied torque at the torque tester with which the electronic torque wrench is engaged. In this regard, the applied torque is produced from a rotational force applied by an operator to the electronic torque wrench.

As the applied torque is detected, the processing circuitry 306 is configured to cause the torque tester 302 to determine a torque value of the applied torque, and determine a time rate of change of the applied torque. The processing circuitry is configured to cause the torque tester to perform comparisons of the torque value and the time rate of change to respectively the target torque value and the threshold time rate of change. And the processing circuitry is configured to cause the torque tester to output a notification to the operator based on the comparisons, the notification output to guide the operator in the rotational force applied by the operator, and thereby the applied torque produced from the rotational force.

When the comparisons indicate the torque value is at least a threshold torque value below the target torque value, the notification may convey that the applied torque is consistent with the specified calibration procedure. The notification may then guide the operator to increase the rotational force and thereby the applied torque, with the rotational force increased at a rate that corresponds to the time rate of change of the applied torque.

When the comparisons also indicate the time rate of change is less than or equal to the threshold time rate of change, the notification may also convey the time rate of change is consistent with the specified calibration procedure. In other cases, the comparisons may indicate the time rate of change is greater than the threshold time rate of change. In these other cases, the notification may convey the time rate of change of the applied torque is inconsistent with the specified calibration procedure. And the notification may therefore guide the operator to reduce the rate at which the rotational force is increased.

When the comparisons indicate the torque value is within a threshold torque value of the target torque value, the notification may convey that the applied torque is at or near the target torque value. This notification, then, may guide the operator to hold the rotational force and thereby the applied torque, which may facilitate calibrating the electronic torque wrench at least for the target torque value.

The notification may be output to guide the operator in any of a number of different manners. In some examples, the torque tester 302 includes one or more transducers 308. In some of these examples, the processing circuitry 306 is configured to cause the torque tester to generate an output signal based on the comparisons, and convert the output signal to user-perceptible feedback by one or more transducers of the torque tester.

The user-perceptible feedback from the one or more transducers 308 may convey that the applied torque is consistent or inconsistent with the specified calibration procedure. In this regard, the applied torque may be consistent with the specified calibration procedure when the applied torque is increased to the target torque value (including when the applied torque is at least a threshold torque value below the target torque value), and the time rate of change is less than or equal to the threshold time rate of change. Conversely, the applied torque may be inconsistent with the specified calibration procedure when the applied torque is more than the threshold torque value above the target torque value. Likewise, the applied torque may be inconsistent with the specified calibration procedure when the time rate of change is greater than the threshold time rate of change.

As shown, the one or more transducers 308 may include one or more electro-optical transducers 310 such as light emitting diode (LED) indicators configured to convert the output signal to visual feedback. In some examples, then, the visual feedback includes pulses of light with either or both of a color or a frequency that depends on at least one of the comparisons. In this regard, the color and/or frequency may convey the applied torque is consistent or inconsistent with the specified calibration procedure.

In addition to or in lieu of electro-optical transducers 310, the one or more transducers 308 may include an electroacoustic transducer 312 such as a loudspeaker configured to convert the output signal to audible feedback. In some of these examples, the audible feedback includes pulses of sound with a frequency that depends on at least one of the comparisons. The frequency of the pulses of sound may therefore convey the applied torque is consistent or inconsistent with the specified calibration procedure. Similarly, the one or more transducers may include an electromechanical transducer 314 configured to convert the output signal to haptic feedback, which may include vibrations with a frequency that depends on at least one of the comparisons, and that conveys the applied torque is consistent or inconsistent with the specified calibration procedure.

In addition to or in lieu of the one or more transducers 308, the system 300 in some examples may further include a computer 316. Examples of suitable computers include personal computers (PCs), handheld computers, mobile phones), remote controls or the like. Examples of handheld computers include mobile computers such as tablet computers, laptops and the like, mobile phones such as smartphones, wearable computers such as smartwatches, and the like. In some of these examples, the processing circuitry 306 may be configured to cause the torque tester 302 generate an output signal based on the comparisons, and send the output signal over a (wired or wireless) data link 318 to the computer at which the output signal is converted to user-perceptible feedback. Similar to above, the computer may be configured to convert the output signal to at least one of haptic, audible or visual feedback.

Regardless of the exact manner by which the notification is output, calibration of the electronic torque wrench 100 may include reading data from the electronic torque wrench as the operator is guided to hold the rotational force and thereby the applied torque when the applied torque is at or near the target torque value. In some examples in which the electronic torque wrench is configured to produce a digital electrical signal that represents the applied torque as sequence of digital data points, the torque value is determined at the torque tester 302 as a reference torque value. The processing circuitry 306 may be configured to cause the torque tester to read the sequence of digital data points from the electronic torque wrench (e.g., as or after the notification is output), such as over a (wired or wireless) data link 320 between the electronic torque wrench and the torque tester. Also in some of these examples, the processing circuitry is configured to cause the torque tester to derive a calibration function from the sequence of digital data points and the reference torque value, and write the calibration function to the electronic torque wrench.

The processing circuitry 306 may be configured to cause the torque tester 302 is caused to convert the sequence of digital data points to a digital value, and derive the calibration function that maps the digital value to the reference torque value. And conversion of the sequence of digital data points may include the torque tester caused to determine a subset of the digital data points in a moving sample window, and calculate the digital value from a rolling average of the subset of the digital data points in the moving sample window.

In some examples, the reference torque value is one of a plurality of reference torque values determined for a plurality of applied torques across a rated torque range of the electronic torque wrench 100. In some of these examples, the sequence of digital data points may be read for the plurality of applied torques, and the calibration function may be derived from the sequence of digital data points and the plurality of reference torque values for the plurality of applied torques.

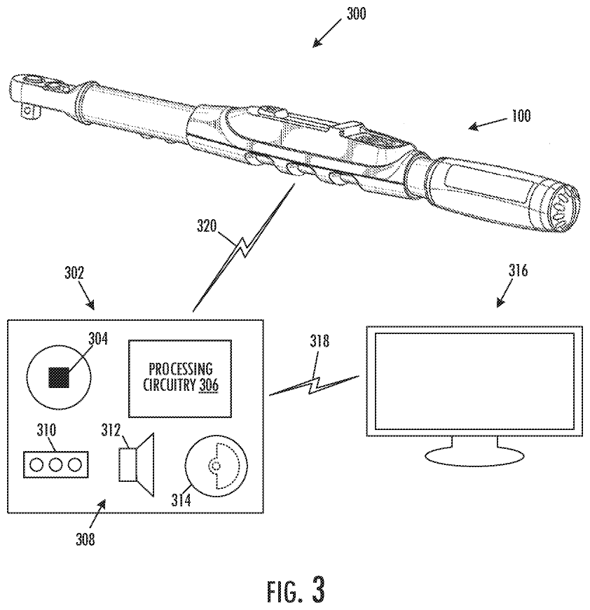

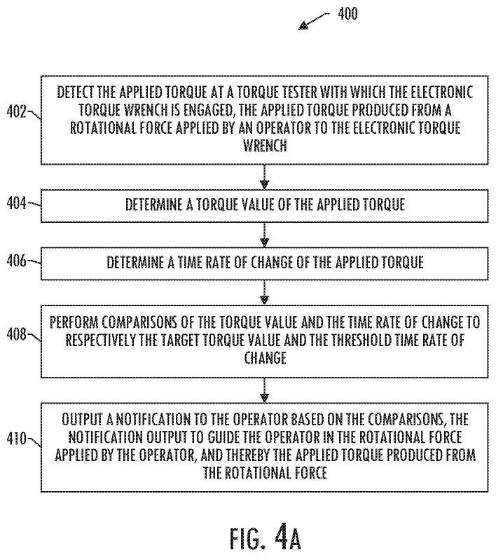

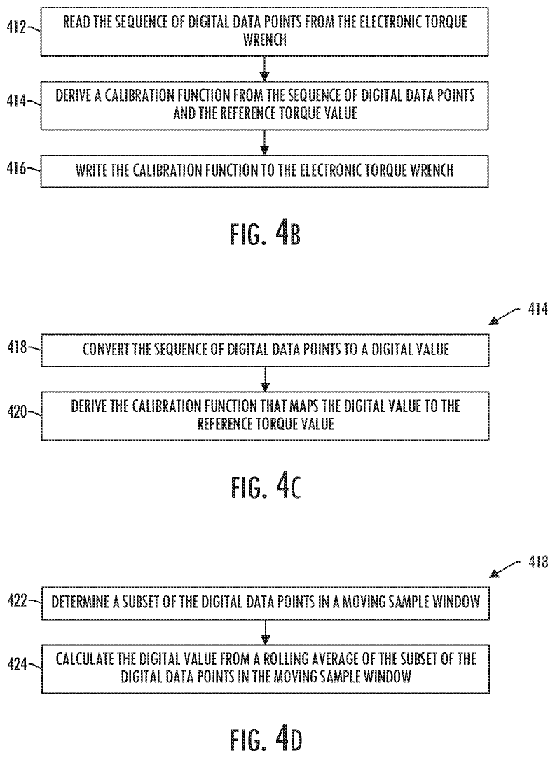

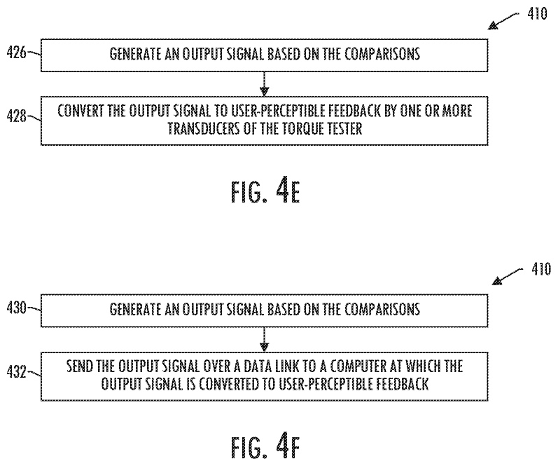

FIGS. 4A-4F are flowcharts illustrating various steps in a method 400 of calibrating an electronic torque wrench engaged with a torque tester, according to a specified calibration procedure that includes increasing an applied torque to a target torque value, and a threshold time rate of change of the applied torque, according to various example implementations. The method includes detecting the applied torque at a torque tester with which the electronic torque wrench is engaged, the applied torque produced from a rotational force applied by an operator to the electronic torque wrench, as shown at block 402 of FIG. 4A. The method includes, as the applied torque is detected, determining a torque value of the applied torque, as shown at block 404. The method includes determining a time rate of change of the applied torque, as shown at block 406. The method includes performing comparisons of the torque value and the time rate of change to respectively the target torque value and the threshold time rate of change, as shown at block 48. And the method includes outputting a notification to the operator based on the comparisons, the notification output to guide the operator in the rotational force applied by the operator, and thereby the applied torque produced from the rotational force, as shown at block 410.

In some examples, the comparisons indicate the torque value is at least a threshold torque value below the target torque value. In some of these examples, the notification conveys that the applied torque is consistent with the specified calibration procedure, and the notification is output at block 410 to guide the operator to increase the rotational force and thereby the applied torque, the rotational force increased at a rate that corresponds to the time rate of change of the applied torque.

In some examples, the comparisons also indicate the time rate of change is less than or equal to the threshold time rate of change. In some of these examples, the notification also conveys the time rate of change is consistent with the specified calibration procedure.

In some examples, the comparisons also indicate the time rate of change is greater than the threshold time rate of change. In some of these examples, the notification also conveys the time rate of change of the applied torque is inconsistent with the specified calibration procedure, and the notification is output at block 410 to guide the operator to reduce the rate at which the rotational force is increased.

In some examples, the comparisons indicate the torque value is within a threshold torque value of the target torque value. In some of these examples, the notification conveys that the applied torque is at or near the target torque value, and the notification is output at block 410 to guide the operator to hold the rotational force and thereby the applied torque.

In some examples, the electronic torque wrench is configured to produce a digital electrical signal that represents the applied torque as sequence of digital data points, and the torque value is determined at the torque tester as a reference torque value. In some of these examples, the method further includes reading the sequence of digital data points from the electronic torque wrench, as shown at block 412 of FIG. 4B. The method includes deriving a calibration function from the sequence of digital data points and the reference torque value, as shown at block 414. And the method includes writing the calibration function to the electronic torque wrench, as shown at block 416.

In some examples, deriving the calibration function at block 414 includes converting the sequence of digital data points to a digital value, as shown at block 418 of FIG. 4C. And the calibration function is derived that maps the digital value to the reference torque value, as shown at block 420.

In some examples, converting the sequence of digital data points at block 418 includes determining a subset of the digital data points in a moving sample window, as shown at block 422 of FIG. 4D. And the method includes calculating the digital value from a rolling average of the subset of the digital data points in the moving sample window, as shown at block 424.

In some examples, the reference torque value is one of a plurality of reference torque values determined for a plurality of applied torques across a rated torque range of the electronic torque wrench. In some of these examples, the sequence of digital data points is read at block 412 for the plurality of applied torques, and the calibration function is derived at block 414 from the sequence of digital data points and the plurality of reference torque values for the plurality of applied torques.

In some examples, outputting the notification at block 410 includes generating an output signal based on the comparisons, as shown at block 426 of FIG. 4E. And the method includes converting the output signal to user-perceptible feedback by one or more transducers of the torque tester, as shown at block 428.

In some examples, the one or more transducers include an electromechanical transducer converting the output signal to haptic feedback.

In some examples, the haptic feedback includes vibrations with a frequency that depends on at least one of the comparisons, and that conveys the applied torque is consistent or inconsistent with the specified calibration procedure.

In some examples, the one or more transducers include an electroacoustic transducer converting the output signal to audible feedback.

In some examples, the audible feedback includes pulses of sound with a frequency that depends on at least one of the comparisons, and that conveys the applied torque is consistent or inconsistent with the specified calibration procedure.

In some examples, the one or more transducers include one or more electro-optical transducers converting the output signal to visual feedback, and the one or more electro-optical transducers include one or more light emitting diode (LED) indicators.

In some examples, the visual feedback includes pulses of light with either or both of a color or a frequency that depends on at least one of the comparisons, and that conveys the applied torque is consistent or inconsistent with the specified calibration procedure.

In some examples, outputting the notification at block 410 includes generating an output signal based on the comparisons, as shown at block 430 of FIG. 4F. And the method includes sending the output signal over a data link to a computer at which the output signal is converted to user-perceptible feedback, as shown at block 432.

In some examples, the output signal is sent at block 432 over the data link to the computer at which the output signal is converted to at least one of haptic, audible or visual feedback.

As explained above and reiterated below, the present disclosure includes, without limitation, the following example implementations.
Clause 1. A torque tester for calibrating an electronic torque wrench, according to a specified calibration procedure that includes increasing an applied torque to a target torque value, and a threshold time rate of change of the applied torque, the torque tester comprising: a recess configured to engage a boss of an electronic torque wrench, and thereby engage the electronic torque wrench with the torque tester; and processing circuitry configured to cause the torque tester to at least: detect the applied torque at the torque tester with which the electronic torque wrench is engaged, the applied torque produced from a rotational force applied by an operator to the electronic torque wrench; and as the applied torque is detected, determine a torque value of the applied torque; determine a time rate of change of the applied torque; perform comparisons of the torque value and the time rate of change to respectively the target torque value and the threshold time rate of change; and output a notification to the operator based on the comparisons, the notification output to guide the operator in the rotational force applied by the operator, and thereby the applied torque produced from the rotational force.
Clause 2. The torque tester of clause 1, wherein the comparisons indicate the torque value is at least a threshold torque value below the target torque value, and wherein the notification conveys that the applied torque is consistent with the specified calibration procedure, and the notification is output to guide the operator to increase the rotational force and thereby the applied torque, the rotational force increased at a rate that corresponds to the time rate of change of the applied torque.
Clause 3. The torque tester of clause 2, wherein the comparisons also indicate the time rate of change is less than or equal to the threshold time rate of change, and wherein the notification also conveys the time rate of change is consistent with the specified calibration procedure.
Clause 4. The torque tester of clause 2 or clause 3, wherein the comparisons also indicate the time rate of change is greater than the threshold time rate of change, and wherein the notification also conveys the time rate of change of the applied torque is inconsistent with the specified calibration procedure, and the notification is output to guide the operator to reduce the rate at which the rotational force is increased.
Clause 5. The torque tester of any of clauses 1 to 4, wherein the comparisons indicate the torque value is within a threshold torque value of the target torque value, and wherein the notification conveys that the applied torque is at or near the target torque value, and the notification is output to guide the operator to hold the rotational force and thereby the applied torque.
Clause 6. The torque tester of any of clauses 1 to 5, wherein the electronic torque wrench is configured to produce a digital electrical signal that represents the applied torque as sequence of digital data points, and the torque value is determined at the torque tester as a reference torque value, and wherein the processing circuitry is configured to cause the torque tester to further at least: read the sequence of digital data points from the electronic torque wrench; derive a calibration function from the sequence of digital data points and the reference torque value; and write the calibration function to the electronic torque wrench.
Clause 7. The torque tester of clause 6, wherein the torque tester caused to derive the calibration function includes the torque tester caused to: convert the sequence of digital data points to a digital value; and derive the calibration function that maps the digital value to the reference torque value.
Clause 8. The torque tester of clause 7, wherein the torque tester caused to convert the sequence of digital data points includes the torque tester caused to: determine a subset of the digital data points in a moving sample window; and calculate the digital value from a rolling average of the subset of the digital data points in the moving sample window.
Clause 9. The torque tester of any of clauses 6 to 8, wherein the reference torque value is one of a plurality of reference torque values determined for a plurality of applied torques across a rated torque range of the electronic torque wrench, and wherein the sequence of digital data points is read for the plurality of applied torques, and the calibration function is derived from the sequence of digital data points and the plurality of reference torque values for the plurality of applied torques.
Clause 10. The torque tester of any of clauses 1 to 9, wherein the torque tester caused to output the notification includes the torque tester caused to: generate an output signal based on the comparisons; and convert the output signal to user-perceptible feedback by one or more transducers of the torque tester.
Clause 11. The torque tester of clause 10, wherein the one or more transducers include an electromechanical transducer configured to convert the output signal to haptic feedback.
Clause 12. The torque tester of clause 11, wherein the haptic feedback includes vibrations with a frequency that depends on at least one of the comparisons, and that conveys the applied torque is consistent or inconsistent with the specified calibration procedure.
Clause 13. The torque tester of any of clauses 10 to 12, wherein the one or more transducers include an electroacoustic transducer configured to convert the output signal to audible feedback.
Clause 14. The torque tester of clause 13, wherein the audible feedback includes pulses of sound with a frequency that depends on at least one of the comparisons, and that conveys the applied torque is consistent or inconsistent with the specified calibration procedure.
Clause 15. The torque tester of any of clauses 10 to 14, wherein the one or more transducers include one or more electro-optical transducers configured to convert the output signal to visual feedback, and the one or more electro-optical transducers include one or more light emitting diode (LED) indicators.
Clause 16. The torque tester of clause 15, wherein the visual feedback includes pulses of light with either or both of a color or a frequency that depends on at least one of the comparisons, and that conveys the applied torque is consistent or inconsistent with the specified calibration procedure.
Clause 17. The torque tester of any of clauses 1 to 16, wherein the torque tester caused to output the notification includes the torque tester caused to: generate an output signal based on the comparisons; and send the output signal over a data link to a computer at which the output signal is converted to user-perceptible feedback.
Clause 18. The torque tester of clause 17, wherein the output signal is sent over the data link to the computer at which the output signal is converted to at least one of haptic, audible or visual feedback.
Clause 19. A method of calibrating an electronic torque wrench engaged with a torque tester, according to a specified calibration procedure that includes increasing an applied torque to a target torque value, and a threshold time rate of change of the applied torque, the method comprising: detecting the applied torque at a torque tester with which the electronic torque wrench is engaged, the applied torque produced from a rotational force applied by an operator to the electronic torque wrench; and as the applied torque is detected, determining a torque value of the applied torque; determining a time rate of change of the applied torque; performing comparisons of the torque value and the time rate of change to respectively the target torque value and the threshold time rate of change; and outputting a notification to the operator based on the comparisons, the notification output to guide the operator in the rotational force applied by the operator, and thereby the applied torque produced from the rotational force.
Clause 20. The method of clause 19, wherein the comparisons indicate the torque value is at least a threshold torque value below the target torque value, and wherein the notification conveys that the applied torque is consistent with the specified calibration procedure, and the notification is output to guide the operator to increase the rotational force and thereby the applied torque, the rotational force increased at a rate that corresponds to the time rate of change of the applied torque.
Clause 21. The method of clause 20, wherein the comparisons also indicate the time rate of change is less than or equal to the threshold time rate of change, and wherein the notification also conveys the time rate of change is consistent with the specified calibration procedure.
Clause 22. The method of clause 20 or clause 21, wherein the comparisons also indicate the time rate of change is greater than the threshold time rate of change, and wherein the notification also conveys the time rate of change of the applied torque is inconsistent with the specified calibration procedure, and the notification is output to guide the operator to reduce the rate at which the rotational force is increased.
Clause 23. The method of any of clauses 19 to 22, wherein the comparisons indicate the torque value is within a threshold torque value of the target torque value, and wherein the notification conveys that the applied torque is at or near the target torque value, and the notification is output to guide the operator to hold the rotational force and thereby the applied torque.
Clause 24. The method of any of clauses 19 to 23, wherein the electronic torque wrench is configured to produce a digital electrical signal that represents the applied torque as sequence of digital data points, and the torque value is determined at the torque tester as a reference torque value, and wherein the method further comprises: reading the sequence of digital data points from the electronic torque wrench; deriving a calibration function from the sequence of digital data points and the reference torque value; and writing the calibration function to the electronic torque wrench.
Clause 25. The method of clause 24, wherein deriving the calibration function includes: converting the sequence of digital data points to a digital value; and deriving the calibration function that maps the digital value to the reference torque value.
Clause 26. The method of clause 25, wherein converting the sequence of digital data points includes: determining a subset of the digital data points in a moving sample window; and calculating the digital value from a rolling average of the subset of the digital data points in the moving sample window.
Clause 27. The method of any of clauses 24 to 26, wherein the reference torque value is one of a plurality of reference torque values determined for a plurality of applied torques across a rated torque range of the electronic torque wrench, and wherein the sequence of digital data points is read for the plurality of applied torques, and the calibration function is derived from the sequence of digital data points and the plurality of reference torque values for the plurality of applied torques.
Clause 28. The method of any of clauses 19 to 27, wherein outputting the notification includes: generating an output signal based on the comparisons; and converting the output signal to user-perceptible feedback by one or more transducers of the torque tester.
Clause 29. The method of clause 28, wherein the one or more transducers include an electromechanical transducer converting the output signal to haptic feedback.
Clause 30. The method of clause 29, wherein the haptic feedback includes vibrations with a frequency that depends on at least one of the comparisons, and that conveys the applied torque is consistent or inconsistent with the specified calibration procedure.
Clause 31. The method of any of clauses 28 to 30, wherein the one or more transducers include an electroacoustic transducer converting the output signal to audible feedback.
Clause 32. The method of clause 31, wherein the audible feedback includes pulses of sound with a frequency that depends on at least one of the comparisons, and that conveys the applied torque is consistent or inconsistent with the specified calibration procedure.
Clause 33. The method of any of clauses 28 to 32, wherein the one or more transducers include one or more electro-optical transducers converting the output signal to visual feedback, and the one or more electro-optical transducers include one or more light emitting diode (LED) indicators.
Clause 34. The method of clause 33, wherein the visual feedback includes pulses of light with either or both of a color or a frequency that depends on at least one of the comparisons, and that conveys the applied torque is consistent or inconsistent with the specified calibration procedure.
Clause 35. The method of any of clauses 19 to 34, wherein outputting the notification includes: generating an output signal based on the comparisons; and sending the output signal over a data link to a computer at which the output signal is converted to user-perceptible feedback.
Clause 36. The method of clause 35, wherein the output signal is sent over the data link to the computer at which the output signal is converted to at least one of haptic, audible or visual feedback.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A torque tester for calibrating an electronic torque wrench, according to a specified calibration procedure that includes increasing an applied torque to a target torque value, and a threshold time rate of change of the applied torque, the torque tester comprising:
a recess configured to engage a boss of an electronic torque wrench, and thereby engage the electronic torque wrench with the torque tester, and
processing circuitry configured to cause the torque tester to at least:
detect the applied torque at the torque tester with which the electronic torque wrench is engaged, the applied torque produced from a rotational force applied by an operator to the electronic torque wrench; and as the applied torque is detected,
determine a torque value of the applied torque;
determine a time rate of change of the applied torque;
perform comparisons of the torque value and the time rate of change to respectively the target torque value and the threshold time rate of change; and
output a notification to the operator based on the comparisons, the notification output to guide the operator in the rotational force applied by the operator, and thereby the applied torque produced from the rotational force.

2. The torque tester of claim 1, wherein the comparisons indicate the torque value is at least a threshold torque value below the target torque value, and
wherein the notification conveys that the applied torque is consistent with the specified calibration procedure, and the notification is output to guide the operator to increase the rotational force and thereby the applied torque, the rotational force increased at a rate that corresponds to the time rate of change of the applied torque.

3. The torque tester of claim 2, wherein the comparisons also indicate the time rate of change is less than or equal to the threshold time rate of change, and
wherein the notification also conveys the time rate of change is consistent with the specified calibration procedure.

4. The torque tester of claim 2, wherein the comparisons also indicate the time rate of change is greater than the threshold time rate of change, and
wherein the notification also conveys the time rate of change of the applied torque is inconsistent with the specified calibration procedure, and the notification is output to guide the operator to reduce the rate at which the rotational force is increased.

5. The torque tester of claim 1, wherein the comparisons indicate the torque value is within a threshold torque value of the target torque value, and
wherein the notification conveys that the applied torque is at or near the target torque value, and the notification is output to guide the operator to hold the rotational force and thereby the applied torque.

6. The torque tester of claim 1, wherein the electronic torque wrench is configured to produce a digital electrical signal that represents the applied torque as sequence of digital data points, and the torque value is determined at the torque tester as a reference torque value, and
wherein the processing circuitry is configured to cause the torque tester to further at least:
read the sequence of digital data points from the electronic torque wrench;
derive a calibration function from the sequence of digital data points and the reference torque value; and
write the calibration function to the electronic torque wrench.

7. The torque tester of claim 1, wherein the torque tester caused to output the notification includes the torque tester caused to:
generate an output signal based on the comparisons; and
convert the output signal to user-perceptible feedback by one or more transducers of the torque tester.

8. The torque tester of claim 7, wherein the one or more transducers include at least one of an electromechanical transducer configured to convert the output signal to haptic feedback, or an electroacoustic transducer configured to convert the output signal to audible feedback, and
wherein at least one of the haptic feedback or the audible feedback includes respectively vibrations or pulses of sound with a frequency that depends on at least one of the comparisons, and that conveys the applied torque is consistent or inconsistent with the specified calibration procedure.

9. The torque tester of claim 7, wherein the one or more transducers include one or more electro-optical transducers configured to convert the output signal to visual feedback, and the one or more electro-optical transducers include one or more light emitting diode (LED) indicators, and
wherein the visual feedback includes pulses of light with either or both of a color or a frequency that depends on at least one of the comparisons, and that conveys the applied torque is consistent or inconsistent with the specified calibration procedure.

10. The torque tester of claim 1, wherein the torque tester caused to output the notification includes the torque tester caused to:
generate an output signal based on the comparisons; and
send the output signal over a data link to a computer at which the output signal is converted to user-perceptible feedback.

11. A method of calibrating an electronic torque wrench engaged with a torque tester, according to a specified calibration procedure that includes increasing an applied torque to a target torque value, and a threshold time rate of change of the applied torque, the method comprising:
detecting the applied torque at a torque tester with which the electronic torque wrench is engaged, the applied torque produced from a rotational force applied by an operator to the electronic torque wrench; and as the applied torque is detected,
determining a torque value of the applied torque,
determining a time rate of change of the applied torque;
performing comparisons of the torque value and the time rate of change to respectively the target torque value and the threshold time rate of change; and
outputting a notification to the operator based on the comparisons, the notification output to guide the operator in the rotational force applied by the operator, and thereby the applied torque produced from the rotational force.

12. The method of claim 11, wherein the comparisons indicate the torque value is at least a threshold torque value below the target torque value, and
wherein the notification conveys that the applied torque is consistent with the specified calibration procedure, and the notification is output to guide the operator to increase the rotational force and thereby the applied torque, the rotational force increased at a rate that corresponds to the time rate of change of the applied torque.

13. The method of claim 12, wherein the comparisons also indicate the time rate of change is less than or equal to the threshold time rate of change, and
wherein the notification also conveys the time rate of change is consistent with the specified calibration procedure.

14. The method of claim 12, wherein the comparisons also indicate the time rate of change is greater than the threshold time rate of change, and
wherein the notification also conveys the time rate of change of the applied torque is inconsistent with the specified calibration procedure, and the notification is output to guide the operator to reduce the rate at which the rotational force is increased.

15. The method of claim 11, wherein the comparisons indicate the torque value is within a threshold torque value of the target torque value, and
wherein the notification conveys that the applied torque is at or near the target torque value, and the notification is output to guide the operator to hold the rotational force and thereby the applied torque.

16. The method of claim 11, wherein the electronic torque wrench is configured to produce a digital electrical signal that represents the applied torque as sequence of digital data points, and the torque value is determined at the torque tester as a reference torque value, and
wherein the method further comprises:
reading the sequence of digital data points from the electronic torque wrench;
deriving a calibration function from the sequence of digital data points and the reference torque value; and
writing the calibration function to the electronic torque wrench.

17. The method of claim 11, wherein outputting the notification includes:
generating an output signal based on the comparisons; and
converting the output signal to user-perceptible feedback by one or more transducers of the torque tester.

18. The method of claim 17, wherein the one or more transducers include at least one of an electromechanical transducer converting the output signal to haptic feedback, or an electroacoustic transducer converting the output signal to audible feedback, and
wherein at least one of the haptic feedback or the audible feedback includes respectively vibrations or pulses of sound with a frequency that depends on at least one of the comparisons, and that conveys the applied torque is consistent or inconsistent with the specified calibration procedure.

19. The method of claim 17, wherein the one or more transducers include one or more electro-optical transducers converting the output signal to visual feedback, and the one or more electro-optical transducers include one or more light emitting diode (LED) indicators, and
wherein the visual feedback includes pulses of light with either or both of a color or a frequency that depends on at least one of the comparisons, and that conveys the applied torque is consistent or inconsistent with the specified calibration procedure.

20. The method of claim 11, wherein outputting the notification includes:
generating an output signal based on the comparisons; and
sending the output signal over a data link to a computer at which the output signal is converted to user-perceptible feedback.
